(19) United States
(12) Patent Application Publication
(10) Pub. No.: US 2021/0136606 A1
(43) Pub. Date: May 6, 2021

(54) RADIO LINK DETECTION METHOD AND APPARATUS AND COMMUNICATION SYSTEM

(71) Applicant: FUJITSU LIMITED, Kawasaki-shi (JP)

(72) Inventors: Meiyi JIA, Beijing (CN); Qinyan JIANG, Beijing (CN); Guorong LI, Beijing (CN); Xin WANG, Beijing (CN)

(73) Assignee: FUJITSU LIMITED, Kawasaki-shi (JP)

(21) Appl. No.: 17/144,951

(22) Filed: Jan. 8, 2021

Related U.S. Application Data
(63) Continuation of application No. PCT/CN2018/099699, filed on Aug. 9, 2018.

(51) Int. Cl. H04W 24/04; H04W 36/16; H04W 36/36

(52) U.S. Cl. CPC H04W 24/04; H04W 36/36; H04W 36/165

(57) ABSTRACT

A radio link detection method and apparatus and a communication system, the radio link detection apparatus being provided in a terminal equipment and including a detector, when a first timer related to radio link monitoring expires, the detector configured to determine that a radio link using an unlicensed frequency band fails, or, when a higher layer of the terminal equipment receives a random access problem indication and a second timer related to reestablishment is not running, the detector determining that a radio link using an unlicensed frequency band fails. Certain embodiments herein may provide for detecting a radio link failure using an unlicensed frequency band.

### CROSS-REFERENCE TO RELATED APPLICATION

This application is a continuation application of International Application PCT/CN2018/099699 filed on Aug. 9, 2018 and designated the U.S., the entire contents of which are incorporated herein by reference.

### TECHNICAL FIELD

This disclosure relates to the field of communication technologies, and in particular to a radio link detection method and apparatus and a communication system.

### BACKGROUND

In existing wireless communication systems, when a specific triggering condition is satisfied, it will be determined as a radio link failure (RLF).

The specific triggering condition may be related to a radio link monitoring (RLM) process. For example, a terminal equipment may monitor a specific signal transmitted by a network device, and determine whether the radio link fails according to a monitoring result.

The specific triggering condition may also be related to a random access procedure. For example, it may be determined whether the radio link fails based on a random access problem indication.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in the related art, for a radio link using a licensed frequency band, whether the radio link fails is determined, so that a terminal restores connection or a network is made to learn the failure; however, in a case of using an unlicensed frequency band for communication, it is also needed that the terminal restores connection or network is made to learn the radio link failure. Therefore, there is a need to perform radio link failure detection on a radio link using the unlicensed frequency band.

Embodiments of this disclosure provide a radio link detection method and apparatus and a communication system, in which it is determined that a radio link using an unlicensed frequency band fails according to a first timer related to radio link monitoring or according to that a higher layer of the terminal equipment receives a random access problem indication and a second timer related to reestablishment. Hence, a radio link failure using an unlicensed frequency band may be detected.

According to a first aspect of the embodiments of this disclosure, there is provided a radio link detection apparatus, provided in a terminal equipment and including a detecting unit, when a first timer related to radio link monitoring expires, the detecting unit determining that a radio link using an unlicensed frequency band fails, or, when a higher layer of the terminal equipment receives a random access problem indication and a second timer related to reestablishment is not running, the detecting unit determining that a radio link using an unlicensed frequency band fails.

According to a second aspect of the embodiments of this disclosure, there is provided a radio link detection apparatus, provided in a network device and including a configuring and transmitting unit, the configuring and transmitting unit configuring a terminal equipment to adjust a parameter used for radio link failure detection and/or to adjust a radio link failure detection process according to a parameter of a channel payload, or transmitting parameters used for representing transmission status of synchronization signal blocks and/or reference signals to the terminal equipment, such that the terminal equipment adjusts the parameter used for radio link failure detection and/or the radio link failure detection process.

According to a third aspect of the embodiments of this disclosure, there is provided a communication system, including a terminal equipment and a network device, the terminal equipment including the radio link detection apparatus as described in the first aspect, and the network device including the radio link detection apparatus as described in the second aspect.

An advantage of the embodiments of this disclosure exists in that a radio link failure using an unlicensed frequency band may be detected.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communication system of this disclosure;

FIG. 2 is a schematic diagram of the radio link detection method of Embodiment 1 of this disclosure;

FIG. 3 is a schematic diagram of the radio link detection method of Embodiment 2 of this disclosure;

FIG. 4 is a schematic diagram of the radio link detection apparatus of Embodiment 3 of this disclosure;

FIG. 5 is a schematic diagram of the radio link detection apparatus of Embodiment 4 of this disclosure;

FIG. 6 is a schematic diagram of a structure of the network device of Embodiment 5 of this disclosure; and

FIG. 7 is a schematic diagram of a structure of the terminal equipment of Embodiment 6 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of this disclosure shall be described below with reference to the accompanying drawings. These embodiments are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

In the embodiments of this disclosure, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE)” refers to, for example, equipment accessing to a communication network and receiving network services via a network device, and may also be referred to as “terminal equipment (TE)”. The terminal equipment may be fixed or mobile, and may also be referred to as a mobile station (MS), a terminal, a subscriber station (SS), an access terminal (AT), or a station, etc.

In the embodiments of this disclosure, the terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios in the embodiments of this disclosure shall be described below by way of examples; however, this disclosure is not limited thereto.

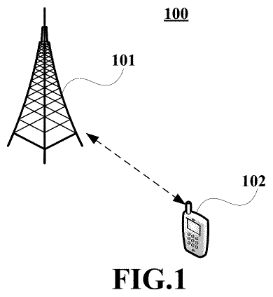

FIG. 1 is a schematic diagram of a communication system of an embodiment of this disclosure, in which a case where a user equipment and a network device are taken as examples is schematically shown. As shown in FIG. 1, a communication system 100 may include a network device 101 and a terminal equipment 102 (for the sake of simplicity, description is given in FIG. 1 by taking one terminal equipment as an example).

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC), etc.

In the embodiments of this disclosure, the terminal equipment 102 may transmit data to the network device 101, for example, in a granted or grant-free transmission mode. The network device 101 may receive data transmitted by one or more terminal equipments 102, and feed back information (such as acknowledgement ACK/non-acknowledgement NACK) to the terminal equipment 102, and the terminal equipment 102 may acknowledge terminating a transmission process according to the feedback information, or may further perform new data transmission, or may perform data retransmission.

Furthermore, before the terminal equipment 102 accesses to the network device 101, the network device 101 may transmit information related to system information to the terminal equipment 102, and the terminal equipment 102 detects the received information to achieve downlink synchronization, and establish connection with the network device 101.

Following description shall be given by taking a network device in a communication system as a transmitter end and a terminal equipment therein as a receiver end as examples. However, this disclosure is not limited thereto, and the transmitter end and the receiver end may also be other devices. For example, this disclosure is applicable not only to signal transmission between a network device and a terminal equipment, but also to signal transmission between two terminal equipments.

### Embodiment 1

The embodiment of this disclosure provides a radio link detection method, which is carried out by a terminal equipment.

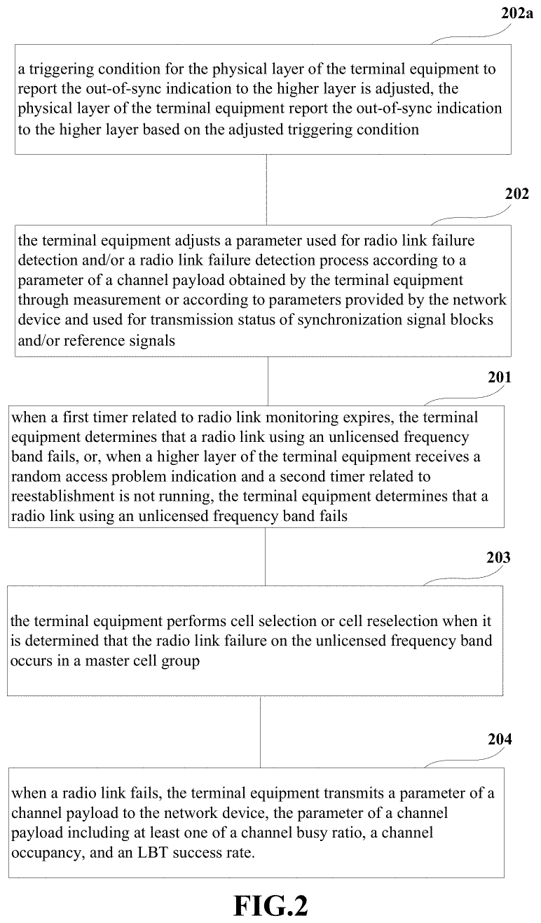

FIG. 2 is a schematic diagram of the radio link detection method of the embodiment of this disclosure. As shown in FIG. 2, the method includes:

step 201: when a first timer related to radio link monitoring expires, the terminal equipment determines that a radio link using an unlicensed frequency band fails, or, when a higher layer of the terminal equipment receives a random access problem indication and a second timer related to reestablishment is not running, the terminal equipment determines that a radio link using an unlicensed frequency band fails.

According to this embodiment, radio link failure detection may be performed on the radio link using the unlicensed frequency band.

In step 201 of this embodiment, the terminal equipment may determine that the radio link using the unlicensed frequency band fails under two conditions. The first condition is that the first timer related to radio link monitoring expires, and the second condition is that the higher layer of the terminal equipment receives the random access problem indication and the second timer related to reestablishment is not running.

In this embodiment, according to the first condition, a process of detecting the failure of the radio link using the unlicensed frequency band by the terminal equipment may be, for example:

when a radio resource control (RRC) layer of the terminal equipment receives a certain number of out of sync indications (such as consecutive N310, i.e. the number of out of sync indications) of a special cell (such as a primary cell (PCell)) or a primary secondary cell (PSCell) indicated by a lower layer, it starts a timer (such as the first timer T310), and when the first timer expires (i.e. an operational time of the first timer exceeds a duration taken as a threshold), the RRC layer determines that the radio link fails.

In addition, during the operation of the first timer T310, if the RRC layer receives a certain number of in-sync indications (such as consecutive N311, i.e. the number of out of sync indications) of the special cell, it may stop the first timer.

In this embodiment, the synchronization indication and the out-of-sync indication are results of monitoring physical layer radio links. When radio link quality on all configured radio link monitoring (RLM) resources of a special cell is worse than a threshold Qₒᵤₜ, the physical layer reports an out-of-sync indication to the higher layer in a frame where the radio link quality is evaluated. When radio link quality on any configured RLM resource of a special cell is better than a threshold Qᵢₙ, the physical layer reports a synchronization indication to the higher layer in the frame where the radio link quality is evaluated.

Regarding a process of detecting a failure of a radio link using an unlicensed frequency band according to the first condition, it was found by the inventors of this disclosure that in performing failure detection on a radio link using an unlicensed frequency band, a special mechanism related to the unlicensed frequency band may have an effect on the radio link failure detection. For example, in using the unlicensed frequency band to provide services for a terminal equipment, both a network device and the terminal equipment need to monitor before communicating, i.e. listen-before-talk (LBT), so as to determine whether a channel is idle. Only when the channel is idle can the network device transmit synchronization blocks, reference signals, downlink control information, and downlink data, etc. Therefore, the busy channel of the unlicensed frequency band will produce interference on the detection of the radio link failure; likewise, the busy channel of the unlicensed frequency band will also have influence on the terminal equipment during the detection and processing of the radio link failure.

In this embodiment, according to the second condition, the process of detecting the failure of the radio link using the unlicensed frequency band by the terminal equipment may be, for example:

when the higher layer of the terminal equipment does not receive a random access response, or the contention resolution is unsuccessful, a counted value of a counter PREAMBLE_TRANSMISSION_COUNTER is added by 1, and when the value of the counter PREAMBLE_TRANSMISSION_COUNTER is preambleTransMax+1, it indicates a random access problem to the higher layer; and when the higher layer receives the indication on random access problem and the second timer (such as T311) related to reestablishment is not running, the terminal equipment determines that the radio link using the unlicensed frequency band fails.

The higher layer of the terminal equipment does not receive the random access response is, for example, it does not receive a correct random access response (RAR) within a window length of a window related to the random access response; that the contention resolution is unsuccessful is, for example, an operational time of a third timer related to random access contention resolution exceeds a preset duration, etc.; and preambleTransMax is a threshold of a number of times of transmission of a random access preamble used for controlling delivery of the random access problem indication to the higher layer of the terminal equipment.

Regarding a process of detecting a failure of a radio link using an unlicensed frequency band according to the second condition, it was also found by the inventors of this disclosure that in performing failure detection on a radio link using an unlicensed frequency band, a special mechanism related to the unlicensed frequency band may have an effect on the radio link failure detection. For example, in using the unlicensed frequency band to provide services for a terminal equipment, both a network device and the terminal equipment need to monitor before communicating, i.e. listen-before-talk (LBT), so as to determine whether a channel is idle. Only when the channel is idle can the network device transmit a random access response or a message 4 used for contention solution. Therefore, the busy channel of the unlicensed frequency band will produce interference on the detection of the radio link failure; likewise, the busy channel of the unlicensed frequency band will also have influence on the terminal equipment during the detection and processing of the radio link failure.

In this embodiment, as shown in FIG. 2, the method may further include:

step 202: the terminal equipment adjusts a parameter used for radio link failure detection and/or a radio link failure detection process according to a parameter of a channel payload obtained by the terminal equipment through measurement or according to parameters provided by the network device and used for transmission status of synchronization signal blocks and/or reference signals.

In this embodiment, after adjusting the parameter used for the detection and/or the detection process in step 202, in step 201, the terminal equipment may determine according to the adjusted parameter used for the detection and/or the adjusted detection process that the radio link using the unlicensed frequency band fails.

In step 202 of this embodiment, the parameter of a channel payload is a parameter representing a channel usage status. The parameter of a channel payload includes at least one of the following: a channel busy ratio (CBR), a channel occupancy (CR), and a listen-before-talk (LBT) success rate.

In this embodiment, the channel busy ratio refers to a ratio of a time of use of a predetermined channel within a first predetermined period of time to the first predetermined period of time. For example, the channel busy ratio may be a ratio of a measurement amount of resources in a configured transmission resource pool with results of measurement higher than a corresponding threshold to a total number of configured resources. The measurement amount may be, for example, a received signal strength identifier (RSSI). The channel busy ratio may be a parameter in the LTE for machine communication and/or in-vehicle communication, or may also be a new parameter introduced for an unlicensed frequency band in new radio (NR).

In this embodiment, the channel occupancy refers to a ratio of the number of resources transmitted or licensed in a predetermined channel within a second predetermined period of time (for example, a period of time of total 1000 subframes before and after a current subframe) to a total number of resources configured in the transmission resource pool. The channel occupancy may be a parameter in the LTE for an unlicensed frequency band, or may also be a new parameter introduced for an unlicensed frequency band in NR.

In this embodiment, the listen-before-talk (LBT) success rate refers to a ratio of the number of times of success of listen-before-talk within a third predetermined period of time to the number of times of all listen-before-talk within the third predetermined period of time.

In step 202 of this embodiment, when the network device is able to transmit, the parameters provided by a network device and used for transmission status of synchronization signal blocks and/or reference signals include at least one of the following:

(1) information on actually transmitted synchronization signal blocks actually transmitted between the network device and the terminal equipment, such as periods, durations and offsets of the synchronization signal blocks, etc.;

(2) offsets of actually transmitted reference signals and/or synchronization signal blocks (SSBs), such as offsets occurred in the actually transmitted reference signals and/or SSBs relative to previously configured RMTC, DMTC or SMTC in a case where transmission of RMTC, discovery signal measurement timing configuration (DMTC) or SMTC out-out-of-window is supported;

(3) the number of pieces or the number of times of being unable to transmit due to LBT within a fourth predetermined period of time, the fourth predetermined period of time being, for example, a period of time from a last time of informing to a current time instant; and

(4) a parameter of a channel payload transmitted by the network device; the parameter of a channel payload has a definition identical to what is described above, and may include, for example, at least one of a channel busy ratio (CBR), a channel occupancy (CR) and a listen-before-talk (LBT) success rate; and the parameter of a channel payload may be, for example, obtained through measurement by another terminal equipment and transmitted to the network device, and transmitted by the network device to the terminal equipment; or the parameter of a channel payload may be obtained by the network device itself, such by measuring by the network device, and transmitted by the network device to the terminal equipment.

In step 202 of this embodiment, the parameter used for radio link failure detection may be a parameter used in the process of detecting the radio link failure according to the first condition, and may, for example, include at least one of the following: a duration of the first timer (T310), the number (N310) of out-of-synchronization indication(s) starting the first timer (T310), the number (N311) of in-synchronization indications stopping the first timer (T310), and a duration of a fourth timer (T312) used for detecting a fast radio link failure (fast RLF) detected.

In this embodiment, the parameters used in the above process of detecting radio link failure according to the first condition are adjusted, hence, even though the network monitors that the channel is busy, the radio link failure may be accurately detected; moreover, as long as the measurement result reaches the report indication, the physical layer always reports the out-of-synchronization indication, and the physical layer is changed less.

A method for adjusting the duration of T310 and the duration of N310, N311 and T312 based on the parameter of a channel payload shall be described below by way of examples. For example,

in a first implementation, the number of out-of-sync indications is adjusted to be N310/(1-channel busy ratio), that is, when N310/(1-channel busy ratio) consecutive out-of-sync indications are received, the first timer T310 is started;

in a second implementation, the duration of the timer T310 is adjusted to be a configured value/(1-channel busy ratio);

in a third implementation, if fast radio link failure (fast RLF) is supported, the duration of timer T312 is adjusted to be the configured value/(1-channel busy ratio); T312 is started when T310 operates and a measurement report of a corresponding measurement object is triggered, and once T312 expires, a process of connection reestablishment is immediately initiated;

in a fourth implementation, the number of synchronization indications is adjusted to N311*(1-channel busy ratio), that is, when N311*(1-channel busy ratio) consecutive out-of-synchronization indications are received, the timer T310 is stopped.

In the above examples, if N310/(1-channel busy ratio), the configured value/(1-channel busy ratio) or N311*(1-channel busy ratio) and parameter values of other adjusted parameters are not integers after being adjusted, they shall be rounded off.

In the above examples, that the channel payload parameter is the channel busy ratio is taken as an example; however, it is not limited thereto; for example, it may also be the channel occupancy or the LBT success rate. If the channel occupancy or the LBT success rate is used for adjustment, the method is inversed, that is, the above division/is replaced with multiplication*, the above multiplication* is replaced with division/, and the above (1-channel busy ratio) is replaced with the channel occupancy ratio or the LBT success rate.

In the above examples, the step of adjusting the parameters may be mandatory or optional, for example, it may be configured by the network device or determined by the terminal equipment itself. The configuring by the network device includes: configuring its application directly by the network device; or, configuring application conditions by the network device, and applying by the terminal after determining that the conditions are satisfied; or configuring by the network device implicitly.

In this embodiment, at least one of high-level signaling, an MAC CE and physical layer control signaling may be used in configuring by the network device directly; a method for configuring the application conditions by the network device may be, for example, indicating a certain measurement quantity (such as RSRP/RSRQ/SINR/channel occupancy) to the terminal, and when a measurement result is higher or lower than the threshold, using the method to adjust the parameters; and the configuring by the network device implicitly may be, for example, configuring the terminal equipment by the network device to use the unlicensed frequency band, hence, the terminal equipment may be implicitly configured to adjust the parameters for the radio link failure detection according to the parameter of a channel payload.

In the above examples, methods for adjusting based on the parameter of a channel payload are described, and reference may be made to the above examples for methods for adjusting based on the parameters provided by the network device and used for synchronization signal blocks and/or transmission status of reference signals.

In step 202 of this embodiment, the adjusted parameters for detecting the radio link failure may also be the parameters used in the above process of detecting radio link failure according to the second condition, for example, the adjusted parameters include at least one of the following parameters: a threshold preambleTransMax of the number of times of transmission of a random access preamble used for controlling delivery of the random access problem indication to the higher layer of the terminal equipment, a window length of a window related to a random access response, and a duration of a third timer related to random access contention resolution. Reference may be made to the above examples for specific adjustment methods of the above parameters.

In this embodiment, by adjusting the parameters used in the above process of detecting the radio link failure according to the second condition, accuracy of detecting radio link failure in the random access process may be improved.

In step 202 of this embodiment, the process of detecting radio link failure may also be adjusted.

The adjusted process of detecting radio link failure may include at least one of the following steps:

(1) when the number out-of-synchronization indications reaches the number (N310) of out-of-synchronization indication(s) starting the first timer (T310), not starting the first timer (T310), but continuing to count, and starting the first timer (T310) until a first indication number (N313) is reached; where, a value of the first indication number (N313) is determined according to the parameters provided by the network device and used for transmission status of synchronization signal blocks and/or reference signals;

(2) when the first timer (T310) is not running, suspending an out-of-synchronization indication counter, using a first counter different from the out-of-synchronization indication counter, and recovering to count by the out-of-synchronization indication counter when a counting value of the first counter reaches the first indication number (N313) of indications; where, a value of the first indication number (N313) is determined according to the parameters provided by the network device and used for transmission status of synchronization signal blocks and/or reference signals;

(3) when the number of times of transmission of random access preambles reaches 1 more than the threshold, not indicating the random access problem by a media access control (MAC) sub-layer of the terminal equipment to the higher layer, but continuing to count the number of times of transmission of random access preambles, and reporting the random access problem to the higher layer until the counting reaches a first number (N1), a value of the first number being determined according to the parameters provided by the network device and used for transmission status of synchronization signal blocks and/or reference signals; and

(4) suspending a counter of the number of times of transmission of random access preambles, using a second counter different from the counter used for counting the number of times of transmission of random access preambles, and recovering to count by the counter of the number of times of transmission of random access preambles until the second counter reaches a second number (N2), a value of the second number being determined according to the parameters provided by the network device and used for transmission status of synchronization signal blocks and/or reference signals.

The counters concerned in the above processes may be implemented by hardware counters or by software programs.

In this embodiment, by adjusting the process of detecting radio link failure, accuracy of detecting a radio link failure triggered by a physical layer issue may be improved, and/or accuracy of detecting a radio link failure in a random access procedure may be improved.

In this embodiment, as shown in FIG. 2, in this method, step 202 may be replaced by step 202a.

In this step 202a, a triggering condition for the physical layer of the terminal equipment to report the out-of-sync indication to the higher layer may be adjusted. Therefore, the physical layer of the terminal equipment may report the out-of-sync indication to the higher layer based on the adjusted triggering condition. Based on the received out-of-sync indication, the higher layer determines according to the parameters used for detection of radio link failure that the radio link using the unlicensed frequency band fails. Hence, behaviors of the physical layer may be changed without needing to change a protocol and implementation of the higher layer.

In one implementation, the triggering condition for the physical layer of the terminal equipment to report the out-of-sync indication to the higher layer may be adjusted as follows: determining by the physical layer according to a relationship between a measurement quantity and a threshold in a combination of thresholds whether to report the out-of-sync indication to the higher layer of the terminal equipment; the combination of thresholds may include at least two thresholds. For example, for the same measurement quantity, such as a PDCCH BLER, or an RSRP/RSRQ/SINR/REEI of an SSB, or an RSRP/RSRQ/SINR/RSSI of a CSI-RS, two thresholds may be used, and when a measurement result is higher or lower than a first threshold and is lower or higher than a second threshold, the out-of-sync indication is reported to the higher layer.

In another implementation, the triggering condition for the physical layer of the terminal equipment to report the out-of-sync indication to the higher layer may be adjusted as follows: determining according to a relationship between the parameter of a channel payload and a threshold whether to report the out-of-sync indication to the physical layer of the terminal equipment; where the parameter of a channel payload may be at least one of a channel busy ratio, a channel occupancy and a listen-before-talk (LBT) success rate. Reference may be made to what is described above for the parameter of a channel payload. In this implementation, for example, when quality of the synchronization signal blocks and/or the reference signals is higher or lower than threshold 1 and the channel busy ratio is lower than threshold 2, the out-of-sync indication is report to the higher layer; and for another example, when quality of the synchronization signal blocks and/or the reference signals is higher or lower than threshold 1 and the channel occupancy or the LBT success rate is higher than threshold 3, the out-of-sync indication is report to the higher layer.

In addition, step 202a may not replace step 202, hence, both parameter and/or process adjustment and triggering condition adjustment are performed.

It was further found by the inventors of this disclosure that when it is determined that the radio link using the unlicensed frequency band fails, if a current mechanism (such as cell selection, or cell reselection, or failure reporting, etc.) is used for processing, due to unique processing of the unlicensed frequency band, such as LBT, etc., it is possible to result in occurrence of radio link failure in a newly-established cell using the unlicensed frequency band. Hence, adjustment of the current mechanism is taken into account.

Processing when a failure of a radio link using an unlicensed frequency band is detected shall be described below.

In this embodiment, as shown in FIG. 2, the method further includes:

step 203: the terminal equipment performs cell selection or cell reselection when it is determined that the radio link failure on the unlicensed frequency band occurs in a master cell group.

In this embodiment, if the terminal equipment is not configured with dual connectivity (DC), or the terminal equipment is configured with DC and the radio link in the master cell group (MCG) fails (i.e. radio link failure occurs), it may be deemed that the radio link in the master cell group fails. In this case, the terminal equipment may stay in the connected state, select a suitable cell and perform connection reestablishment, i.e. cell selection or cell reselection after cell selection. If it is determined that a suitable cell is not found within a period of time after the radio link fails, the UE enters an idle state.

In step 203, when the terminal equipment performs cell selection, at least one of the following modes may be adopted that:

(1) in a criterion for cell selection, such as a criterion S, the unlicensed frequency band uses a first threshold, the first threshold being different from or identical to a second threshold used for a licensed frequency band; for example, the network device provides a specific minimum value to the unlicensed frequency band via system information (such as SIB1); the specific minimum value is an example of the first threshold, and may be, for example, Qrxlevmin and/or Qqualmin; where, Qrxlevmin is a minimum value of a reception level, i.e. a minimum reception value of RSRP, and Qqualmin is a minimum value of reception quality, i.e. a minimum reception value of RSRQ;

(2) the criterion for cell selection (such as the criterion S) is adjusted by an offset related to a channel payload; the channel payload is, for example, a channel payload determined by the network device; for example, the network device provides the offset Qoffset_{load} via system information (such as SIB1), and based on the offset, the criterion S may be adjusted to be:

Srxlev=Qrxlevmeas−(Qrxlevmin+Qrxlevoffset)−Pcompensation−Qoffsetₜₑₘₚ−Qoffset_{load} Squal=Qqualmeas−(Qqualmin+Qqualoffset)−Qoffsetₜₑₘₚ−Qoffset_{load};

(3) in the criterion for cell selection (such as the criterion S), a measurement quantity related to the channel payload is used; the channel payload is, for example, a channel payload determined by the network device, the measurement quantity related to the channel payload may be expressed as Sload, and base upon the measurement quantity Sload, the criterion S may be, for example, Srxlev>0 and Squal>0 and Sload<0;

in one implementation, the measurement quantity Sload may be obtained by the equation as below:

Sload=Qloadmeas−(Qloadmax+Qloadmaxoffset)−Qoffsetₜₑₘₚ₁;

where, Qloadmeas may be a proportion of amounts of measurement in amounts of measurement of a cell with RSSI values higher than a threshold, Qload may be a configured maximum value, Qloadmaxoffset and Qoffsetₜₑₘₚ₁ may be two adjustment values, and Qloadmeas, Qloadmax, Qloadmaxoffset and Qoffsetₜₑₘₚ₁ are all ratios with no unit;

(4) in the criterion for cell selection, a threshold and/or an offset of the measurement quantity related to the channel payload determined by the network device is/are used.

In step 203, when the terminal equipment performs cell reselection, at least one of the following methods may be adopted:

(1) setting a priority of the unlicensed frequency band to be lower than a priority of the licensed frequency band by the terminal equipment;

(2) adjusting a criterion for cell reselection by an offset related to a channel payload; the channel payload may be determined by the network device, and the criterion for cell reselection may be, for example, an R criterion for ordering intra-frequency cells and inter-frequency cell of identical priorities; for example, the offset related to a channel payload may be expressed as Qoffsetload, and a neighboring cell ordering criterion of the R criterion is adjusted to be Rn=Q_{meas,n}−Qoffset−Qoffset_{load};

(3) in the criterion for cell reselection (such as the R criterion), a measurement quantity related to the channel payload determined by the network device is used; reference may be made to (3) above in which the terminal equipment performing cell selection is described; and

(4) in the criterion for cell reselection, a threshold and/or an offset of the measurement quantity related to the channel payload determined by the network device is/are used.

In this embodiment, as shown in FIG. 2, the method may further include:

step 204: when a radio link fails, the terminal equipment transmits a parameter of a channel payload to the network device, the parameter of a channel payload including at least one of a channel busy ratio, a channel occupancy, and an LBT success rate.

The parameter of a channel payload may include: a last payload measurement result of a last serving cell, and/or a load measurement result of a listed cell.

The last serving cell refers to a cell or a primary cell where a radio link fails, and the payload measurement result may be a cell-level load-related measurement result and/or an SSB/CSI-RS-level load-related measurement result.

A specific parameter of the parameter of a channel payload may be at least one of a channel busy ratio, a channel occupancy, and an LBT success rate, and reference may be made to the description of the parameter of a channel payload in step 202 for an explanation of the parameter of a channel payload.

In one implementation of step 204 of this embodiment, when the radio link using the unlicensed frequency band fails, after re-establishing the connection through cell selection or cell reselection, if the terminal equipment has a parameter of a channel payload of a previously failed cell, the terminal equipment may report the parameter of a channel payload of the previously failed cell to the network side. The parameter of a channel payload may be transmitted via at least one of the following messages: a radio resource control (RRC) connection reconfiguration complete message, a radio resource control (RRC) connection reestablishment complete message, a radio resource control (RRC) connection response complete message, a radio resource control (RRC) connection setup complete message, a measurement report message, and a terminal equipment information response message.

In another implementation of step 204 of this embodiment, when a radio link using an unlicensed frequency band fails, if the terminal does not need connection reestablishment, the terminal equipment may transmit a failure report to the network device to report the radio link failure. The case where the terminal does not need connection reestablishment may be, for example, that the terminal equipment is configured with DC and the radio link fails in a secondary cell group; the terminal equipment performs duplication transmission and a link fails in one of cells where the duplication transmission is performed.

In this implementation, if the terminal equipment has the parameter of a channel payload of the failed cell, the failure report may include the parameter of a channel payload of the failed cell. The failure report may be carried in a secondary cell group (SCG) information report message and transmitted.

In this embodiment, step 203, step 204 and step 201 may be combined to perform detection and processing of radio link failure. As step 202 may not be used, a protocol and implementation of the physical layer is not affected, and a protocol and implementation of the higher layer is affected less, thereby saving development costs. In addition, when cell selection and cell reselection are performed, selection may be made according to a parameter of a signal payload, so that a selected cell is more suitable. Moreover, the terminal equipment provides the parameter of a channel payload to the network device, which may help the network device to collect information, thereby facilitating adjustment of mobility parameters, and better serving for the terminal equipment.

In this embodiment, step 203, step 204, step 201 and step 202 may also be combined to perform detection and processing of radio link failure, thereby not only improving accuracy of detection of radio link failure, but also selecting more suitable cells when a radio link failure is detected.

### Embodiment 2

Embodiment 2 of this disclosure provides a radio link detection method, which is carried out by a network device.

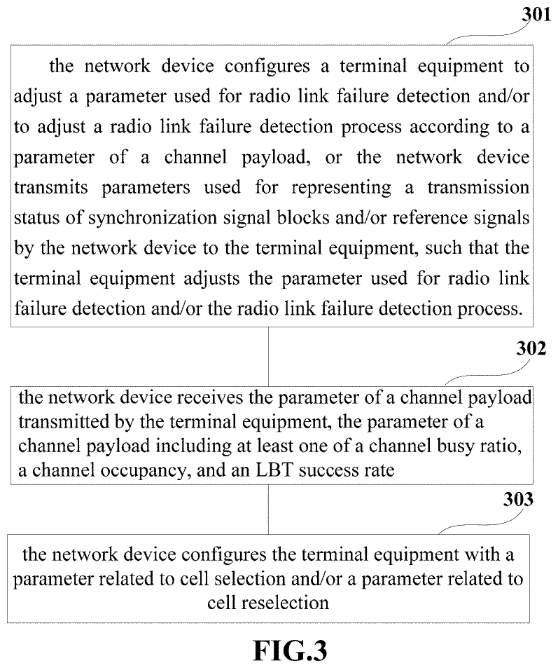

FIG. 3 is a schematic diagram of the radio link detection method of Embodiment 2 of this disclosure. As shown in FIG. 3, the method includes:

step 301: the network device configures a terminal equipment to adjust a parameter used for radio link failure detection and/or to adjust a radio link failure detection process according to a parameter of a channel payload, or the network device transmits parameters used for representing a transmission status of synchronization signal blocks and/or reference signals by the network device to the terminal equipment, such that the terminal equipment adjusts the parameter used for radio link failure detection and/or the radio link failure detection process.

In step 301 of this embodiment, the parameter of a channel payload is a parameter representing a channel usage status. And the parameter of a channel payload includes at least one of the following: a channel busy ratio, a channel occupancy, and a listen-before-talk (LBT) success rate.

In this embodiment, the channel busy ratio refers to a ratio of a time of use of a predetermined channel within a first predetermined period of time to the first predetermined period of time, the channel occupancy refers to a ratio of the number of resources transmitted or licensed in a predetermined channel within a second predetermined period of time to a total number of resources configured in a transmission resource pool, and the listen-before-talk (LBT) success rate refers to a ratio of the number of times of success of listen-before-talk within a third predetermined period of time to the number of times of all listen-before-talk within the third predetermined period of time.

In step 301 of this embodiment, the parameters provided by the network device and used for representing transmission status of synchronization signal blocks and/or reference signals include at least one of the following: information on actually transmitted synchronization signal blocks actually transmitted between the network device and the terminal equipment, offsets of actually transmitted reference signals and/or synchronization signal blocks (SSBs), the number of pieces or the number of times of being unable to transmit due to LBT within a fourth predetermined period of time, and a parameter of a channel payload transmitted by the network device.

Reference may be made to Embodiment 1 for the parameters used in the detection of radio link failure and/or the process of detecting a radio link failure.

In this embodiment, as shown in FIG. 3, the method further includes:

step 302: the network device receives the parameter of a channel payload transmitted by the terminal equipment, the parameter of a channel payload including at least one of a channel busy ratio, a channel occupancy, and an LBT success rate.

In step 302, the parameter of a channel payload is transmitted via at least one of the following:

a radio resource control (RRC) connection reconfiguration complete message, a radio resource control (RRC) connection reestablishment complete message, a radio resource control (RRC) connection response complete message, a radio resource control (RRC) connection setup complete message, a measurement report message, a terminal equipment information response message, and a secondary cell group (SCG) information report message.

In this embodiment, as shown in FIG. 3, the method further includes:

step 303: the network device configures the terminal equipment with a parameter related to cell selection and/or a parameter related to cell reselection.

In one implementation, the parameter related to cell selection configured by the network device for the terminal equipment is at least one of the following: in a criterion for cell selection, a first threshold used for an unlicensed frequency band, the first threshold being different from or identical to a second threshold used for a licensed frequency band; an offset related to a channel payload and used for the criterion for cell selection determined by the network device; a measurement quantity related to the channel payload and used for the criterion for cell selection determined by the network device; a threshold and/or an offset of the measurement quantity related to the channel payload in the criterion for cell selection determined by the network device.

In another implementation, the parameter related to cell reselection configured by the network device for the terminal equipment is at least one of the following: a priority of the licensed frequency band being lower than a priority of the unlicensed frequency band; an offset related to a channel payload used for the criterion for cell reselection and determined by the network device; a measurement quantity related to the channel payload used for the criterion for cell reselection and determined by the network device; a threshold and/or an offset of the measurement quantity related to the channel payload in the criterion for cell reselection determined by the network device.

In this embodiment, with step 303, when a radio link fails and the terminal equipment needs to reselect a cell, the terminal equipment may perform cell selection or reselection according to the parameters configured in step 303.

In the method of this embodiment, there may be only step 301, hence, accuracy of detection of radio link failure performed by the terminal equipment may be improved. In the method of this embodiment, there may also be only step 302 or step 303, hence, when a radio link fails, the network device may be assisted to collect information, or the terminal equipment is facilitated to select a more suitable cell. In the method of this embodiment, there may also be any two or three of step 301, step 302 and step 303, hence, the method may integrate advantages of each step.

### Embodiment 3

Embodiment 3 of this disclosure provides a radio link detection apparatus, which is configured in a terminal equipment. As a principle of the apparatus for solving problems is similar to that of the method in Embodiment 1, reference may be made to the implementation of the method in Embodiment 1 for implementation of this apparatus, with identical contents being going to be described herein any further.

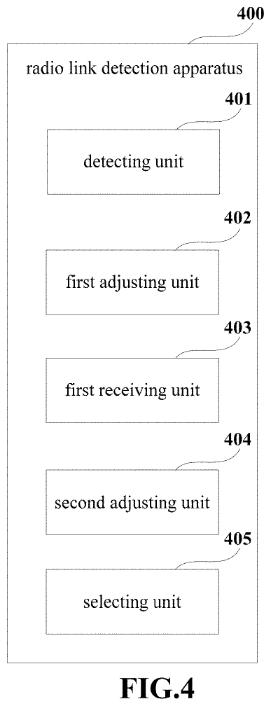

FIG. 4 is a schematic diagram of the radio link detection apparatus of Embodiment 3 of this disclosure. As shown in FIG. 4, a radio link detection apparatus 400 includes a detecting unit 401.

In this embodiment, when a first timer related to radio link monitoring expires, the detecting unit 401 determines that a radio link using an unlicensed frequency band fails; or, when a higher layer of the terminal equipment receives a random access problem indication and a second timer related to reestablishment is not running, the detecting unit 401 determines that a radio link using an unlicensed frequency band fails.

In this embodiment, as shown in FIG. 4, the apparatus 400 may further include: a first adjusting unit 402. The first adjusting unit 402 is configured to adjust a parameter used for radio link failure detection and/or to adjust a radio link failure detection process according to a parameter of a channel payload obtained by the terminal equipment through measurement or according to parameters provided by a network device and used for transmission status of synchronization signal blocks and/or reference signal. Hence, the detecting unit 401 determines according to the adjusted parameter and/or the adjusted process that a radio link using the unlicensed frequency band fails.

In this embodiment, as shown in FIG. 4, the apparatus 400 may further include: a first receiving unit 403. The first receiving unit 403 is configured to receive a configuration of the network device; wherein the first adjusting unit 402 adjusts the parameter used for radio link failure detection based on the configuration of the network device.

In this embodiment, as shown in FIG. 4, the apparatus 400 may further include: a second adjusting unit 404. The second adjusting unit 404 is configured to control a physical layer of the terminal equipment to determine whether to report the out-of-synchronization indication to the higher layer of the terminal equipment according to a relationship between a measurement quantity and a threshold in a combination of thresholds, or according to a relationship between the parameter of a channel payload and a threshold; wherein the combination of thresholds includes at least two thresholds, and the detecting unit 401 determines to use radio link failure of the unlicensed frequency band based on the received out-of-synchronization indication and according to the parameter used for radio link failure detection.

In this embodiment, as shown in FIG. 4, the apparatus 400 may further include: a selecting unit 405. The selecting unit 405 is configured to perform cell selection or cell reselection when the radio link fails in a primary cell group.

In this embodiment, reference may be made to the steps in Embodiment 1 for the units in this embodiment.

According to this embodiment, the radio link failure of the unlicensed frequency band may be detected, accuracy of the detection of the radio link failure may be improved, and more suitable cells may be selected when a radio link failure is detected.

### Embodiment 4

Embodiment 4 of this disclosure provides a radio link detection apparatus, which is configured in a network device. As a principle of the apparatus for solving problems is similar to that of the method in Embodiment 2, reference may be made to the implementation of the method in Embodiment 2 for implementation of this apparatus, with identical contents being going to be described herein any further.

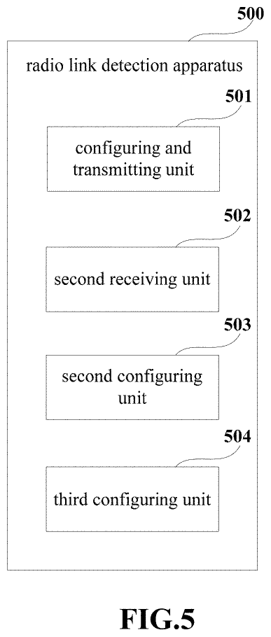

FIG. 5 is a schematic diagram of the radio link detection apparatus of Embodiment 4 of this disclosure. As shown in FIG. 5, a radio link detection apparatus 500 includes: a configuring and transmitting unit 501. The configuring and transmitting unit 501 configures a terminal equipment to adjust parameter used for radio link failure detection and/or to adjust a radio link failure detection process according to a parameter of a channel payload, or transmits parameters used for representing a transmission status of synchronization signal blocks and/or reference signals to the terminal equipment, such that the terminal equipment adjusts the parameter used for radio link failure detection and/or the radio link failure detection process.

As shown in FIG. 5, the apparatus 500 may further include: a second receiving unit 502. When a radio link failure occurs, the second receiving unit 502 receives the parameter of a channel payload transmitted by the terminal equipment, the parameter of a channel payload including at least one of a channel busy ratio, a channel occupancy, and an LBT success rate.

As shown in FIG. 5, the apparatus 500 may further include: a second configuring unit 503 or a third configuring unit 504. The second configuring unit 503 configures the terminal equipment with a parameter related to cell selection, and the third configuring unit 504 configures the terminal equipment with a parameter related to cell reselection.

In this embodiment, reference may be made to the steps in Embodiment 2 for the units in this embodiment.

According to this embodiment, accuracy of the detection of the radio link failure may be improved, and when a radio link failure occurs, the network device may be assisted to collect information, or the terminal equipment is facilitated to select a more suitable cell.

### Embodiment 5

The embodiment of this disclosure provides a network device. As a principle of the network device for solving problems is similar to that of the method in Embodiment 2, reference may be made to the implementation of the method in Embodiment 2 for implementation of this network device, with identical contents being going to be described herein any further.

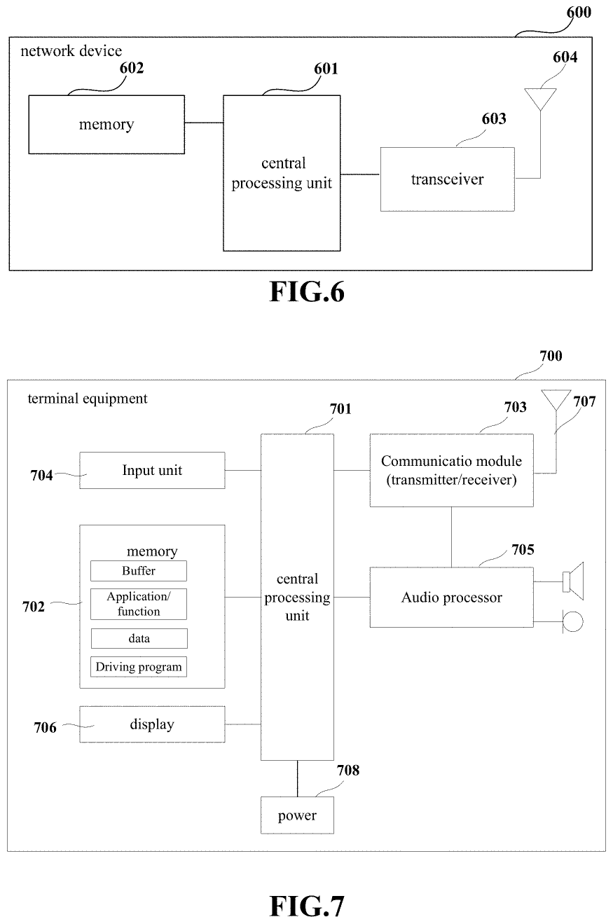

FIG. 6 is a schematic diagram of a structure of the network device of the embodiment of this disclosure. As shown in FIG. 6, a network device 600 may include a central processing unit (CPU) 601 and a memory 602, the memory 602 being coupled to the central processing unit 601. The memory 602 may store various data, and furthermore, it may store a program for data processing, and execute the program under control of the central processing unit 601.

In one implementation, the functions of the apparatus 500 may be integrated into the central processing unit 601. The central processing unit 601 may be configured to carry out the radio link detection method described in Embodiment 2.

For example, the central processing unit 601 may be configured to perform control, such that the network device 600 carries out the method described in Embodiment 2.

Furthermore, reference may be made to Embodiment 2 for other configuration methods of the central processing unit 601, which shall not be described herein any further.

In another implementation, the apparatus 500 and the central processing unit 601 may be configured separately; for example, the apparatus 500 may be configured as a chip connected to the central processing unit 601, such as units shown in FIG. 6, and the functions of the apparatus 500 are executed under control of the central processing unit 601.

Furthermore, as shown in FIG. 6, the network device 600 may include a transceiver 603, and an antenna 604, etc. Functions of the above components are similar to those in the related art, and shall not be described herein any further. It should be noted that the network device 600 does not necessarily include all the parts shown in FIG. 6. Furthermore, the network device 600 may include parts not shown in FIG. 6, and the related art may be referred to.

According to this embodiment, accuracy of the detection of the radio link failure by the terminal equipment may be improved, and when a radio link fails, the network device may be assisted to collect information, or the terminal equipment is facilitated to select a more suitable cell.

### Embodiment 6

The embodiment of this disclosure provides a terminal equipment. As a principle of the terminal equipment for solving problems is similar to that of the method in Embodiment 1, reference may be made to the implementation of the method in Embodiment 1 for implementation of this terminal equipment, with identical contents being going to be described herein any further.

FIG. 7 is a schematic diagram of a structure of the terminal equipment of the embodiment of this disclosure. As shown in FIG. 7, a terminal equipment 700 may include a central processing unit (CPU) 701 and a memory 702, the memory 702 being coupled to the central processing unit 701. The memory 702 may store various data, and furthermore, it may store a program for data processing, and execute the program under control of the central processing unit 701, so as to indicate to the terminal equipment according to received signaling.

In one implementation, the functions of the apparatus 400 in Embodiment 3 may be integrated into the central processing unit 701 of the terminal equipment 700. The central processing unit 701 may be configured to carry out the radio link detection method described in Embodiment 1.

For example, the central processing unit 701 may be configured to perform control, such that the terminal equipment 700 carries out the method described in Embodiment 1.

Furthermore, reference may be made to Embodiment 1 for other configuration methods of the central processing unit 701, which shall not be described herein any further.

In another implementation, the apparatus 400 and the central processing unit 701 may be configured separately; for example, the apparatus 400 may be configured as a chip connected to the central processing unit 701, such as units shown in FIG. 7, and the functions of the apparatus 400 are executed under control of the central processing unit 701.

According to this embodiment, the radio link failure of the unlicensed frequency band may be detected, accuracy of the detection of the radio link failure may be improved, and more suitable cells may be selected when a radio link failure is detected.

### Embodiment 7

Embodiment 7 of this disclosure provides a communication system, including at least the network device 600 in Embodiment 5 and/or the terminal equipment 700 in Embodiment 6. Contents of Embodiment 5 and Embodiment 6 are incorporated herein, and shall not be described herein any further.

An embodiment of this disclosure provides a computer storage medium, including a computer readable program code, which will cause a radio link detection apparatus or a terminal equipment to carry out the radio link detection method described in Embodiment 1.

An embodiment of the present disclosure provides a computer readable program code, which, when executed in a radio link detection apparatus or a terminal equipment, will cause the radio link detection apparatus or the terminal equipment to carry out the radio link detection method described in Embodiment 1.

An embodiment of this disclosure provides a computer storage medium, including a computer readable program code, which will cause a radio link detection apparatus or a network device to carry out the radio link detection method described in Embodiment 2.

An embodiment of the present disclosure provides a computer readable program code, which, when executed in a radio link detection apparatus or a network device, will cause the radio link detection apparatus or the network device to carry out the radio link detection method described in Embodiment 2.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIGS. 4 and 5 may either correspond to software modules of procedures of a computer program, or correspond to hardware modules. Such software modules may respectively correspond to the steps shown in FIGS. 2 and 3. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 4 and 5 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIGS. 4 and 5 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

Following supplements are further provided in this disclosure.

1. A radio link detection apparatus, provided in a terminal equipment and including a detecting unit,

when a first timer related to radio link monitoring expires, the detecting unit determining that a radio link using an unlicensed frequency band fails,

or, when a higher layer of the terminal equipment receives a random access problem indication and a second timer related to reestablishment is not running, the detecting unit determining that a radio link using an unlicensed frequency band fails.

2. The apparatus according to supplement 1, wherein the apparatus further includes:

a first adjusting unit configured to adjust a parameter used for radio link failure detection and/or to adjust a radio link failure detection process according to a parameter of a channel payload obtained by the terminal equipment through measurement or according to parameters provided by a network device and used for transmission status of synchronization signal blocks and/or reference signals;

wherein the detecting unit determines according to the adjusted parameter and/or the adjusted process that a radio link using the unlicensed frequency band fails.

3. The apparatus according to supplement 2, wherein,

the parameter used for radio link failure detection includes at least one of the following:

a duration of the first timer (T310), the number (N310) of out-of-synchronization indication(s) starting the first timer (T310), the number (N311) of in-synchronization indication stopping the first timer (T310), and a duration of a fourth timer (T312) used for a fast radio link failure (fast RLF) detection;

or, the parameter used for radio link failure detection includes at least one of the following:

a threshold of the number of times of random access preamble transmission used for controlling delivery of the random access problem indication to the higher layer of the terminal equipment, a length of a window related to a random access response, and a duration of a third timer related to random access contention resolution.

4. The apparatus according to supplement 2, wherein the adjusted radio link failure detection process includes at least one of the following steps:

when the number out-of-synchronization indications reaches the number (N310) of out-of-synchronization(s) indications starting the first timer (T310), not starting the first timer (T310), but continuing to count, and starting the first timer (T310) until a first indication number (N313) is reached; wherein a value of the first indication number (N313) is determined according to the parameters provided by the network device and used for transmission status of synchronization signal blocks and/or reference signals;

when the first timer (T310) is not running, suspending an out-of-synchronization indication counter, using a first counter different from the out-of-synchronization indication counter, and recovering to count by the out-of-synchronization indication counter when a counting value of the first counter reaches the first indication number (N313); wherein a value of the first indication number (N313) is determined according to the parameters provided by the network device and used for transmission status of synchronization signal blocks and/or reference signals;

when the number of times of transmission of random access preambles reaches 1 more than the threshold, not indicating the random access problem by a media access control (MAC) sub-layer of the terminal equipment to the higher layer, but continuing to count the number of times of transmission of random access preambles, and reporting the random access problem to the higher layer until the counting reaches a first number (N1), a value of the first number being determined according to the parameters provided by the network device and used for transmission status of synchronization signal blocks and/or reference signals; and

suspending a counter of the number of times of transmission of random access preambles, using a second counter different from the counter used for counting the number of times of transmission of random access preambles, and recovering to count by the counter of the number of times of transmission of random access preambles until the second counter reaches a second number (N2), a value of the second number being determined according to the parameters provided by the network device and used for transmission status of synchronization signal blocks and/or reference signals.

5. The apparatus according to supplement 2, wherein,
the parameter of a channel payload is a parameter representing a channel usage status.

6. The apparatus according to supplement 5, wherein,

the parameter of a channel payload includes at least one of the following:

a channel busy ratio, a channel occupancy, and a listen-before-talk (LBT) success rate.

7. The apparatus according to supplement 6, wherein,

the channel busy ratio is a ratio of a time of use of a predetermined channel within a first predetermined period of time to the first predetermined period of time.

8. The apparatus according to supplement 6, wherein,

the channel occupancy is a ratio of the number of resources transmitted or licensed in a predetermined channel within a second predetermined period of time to a total number of resources configured in a transmission resource pool.

9. The apparatus according to supplement 6, wherein,

the listen-before-talk (LBT) success rate is a ratio of the number of times of success of listen-before-talk within a third predetermined period of time to the number of times of all listen-before-talk within the third predetermined period of time.

10. The apparatus according to supplements 2-9, wherein the apparatus further includes:

a first receiving unit configured to receive a configuration of the network device;

wherein the first adjusting unit adjusts the parameter used for radio link failure detection based on the configuration of the network device.

11. The apparatus according to supplement 2, wherein,

the parameters provided by the network device and used for representing transmission status of synchronization signal blocks and/or reference signals include at least one of the following:

information on actually transmitted synchronization signal blocks actually transmitted between the network device and the terminal equipment, offsets of actually transmitted reference signals and/or synchronization signal blocks (SSBs), the number of pieces or the number of times of being unable to transmit due to LBT within a fourth predetermined period of time, and a parameter of a channel payload transmitted by the network device.

12. The apparatus according to any one of supplements 1-11, wherein the apparatus further includes:

a selecting unit configured to perform cell selection or cell reselection when the radio link fails in a primary cell group.

13. The apparatus according to supplement 12, wherein,

when the selecting unit performs cell selection,

in a criterion for cell selection, a first threshold is used for the unlicensed frequency band, the first threshold being different from or identical to a second threshold used for a licensed frequency band; or

the criterion for cell selection is adjusted by an offset related to a channel payload determined by the network device; or

in the criterion for cell selection, a measurement quantity related to the channel payload determined by the network device is used; or

in the criterion for cell selection, a threshold and/or an offset of the measurement quantity related to the channel payload determined by the network device is/are used.

14. The apparatus according to supplement 12, wherein,

when the selecting unit performs cell reselection,

the terminal equipment sets a priority of the unlicensed frequency band to be lower than a priority of a licensed frequency band; or

a criterion for cell reselection is adjusted by an offset related to a channel payload determined by the network device; or

in the criterion for cell reselection, a measurement quantity related to the channel payload determined by the network device is used; or

in the criterion for cell reselection, a threshold and/or an offset of the measurement quantity related to the channel payload determined by the network device is/are used.

15. The apparatus according to any one of supplements 1-12, wherein the apparatus further includes:

a first transmitting unit configured to transmit the parameter of a channel payload to the network device when the radio link fails, the parameter of a channel payload including at least one of a channel busy ratio, a channel occupancy, and an LBT success rate.

16. The apparatus according to supplement 15, wherein the parameter of a channel payload is transmitted via at least one of the following:

a radio resource control (RRC) connection reconfiguration complete message, a radio resource control (RRC) connection reestablishment complete message, a radio resource control (RRC) connection response complete message, a radio resource control (RRC) connection setup complete message, a measurement report message, a terminal equipment information response message, and a secondary cell group (SCG) information report message.

17. The apparatus according to supplement 1, wherein,

a second adjusting configured to control a physical layer of the terminal equipment to determine whether to report the out-of-synchronization indication to the higher layer of the terminal equipment according to a relationship between a measurement quantity and a threshold in a combination of thresholds, or according to a relationship between the parameter of a channel payload and a threshold;

wherein the combination of thresholds includes at least two thresholds,

and the detecting unit determines to use radio link failure of the unlicensed frequency band based on the received out-of-synchronization indication and according to the parameter used for radio link failure detection.

18. A radio link detection apparatus, provided in a network device and including a configuring and transmitting unit, the configuring and transmitting unit,

configuring a terminal equipment to adjust parameter used for radio link failure detection and/or a radio link failure detection process according to a parameter of a channel payload, or

transmitting parameters used for transmission status of denoting synchronization signal blocks and/or reference signals to the terminal equipment, such that the terminal equipment adjusts the parameter used for radio link failure detection and/or the radio link failure detection process.

19. The apparatus according to supplement 18, wherein,

the parameter of a channel payload is a parameter representing a channel usage status.

20. The apparatus according to supplement 19, wherein,

the parameter of a channel payload includes at least one of the following:

a channel busy ratio, a channel occupancy, and a listen-before-talk (LBT) success rate.

21. The apparatus according to supplement 20, wherein,

the channel busy ratio is a ratio of a time of use of a predetermined channel within a first predetermined period of time to the first predetermined period of time.

22. The apparatus according to supplement 20, wherein,

the channel occupancy is a ratio of the number of resources transmitted or licensed in a predetermined channel within a second predetermined period of time to a total number of resources configured in a transmission resource pool.

23. The apparatus according to supplement 20, wherein,

the listen-before-talk (LBT) success rate is a ratio of the number of times of success of listen-before-talk within a third predetermined period of time to the number of times of all listen-before-talk within the third predetermined period of time.

24. The apparatus according to supplement 18, wherein,

the parameters used for representing transmission status of synchronization signal blocks and/or reference signals include at least one of the following:

information on actually transmitted synchronization signal blocks actually transmitted between the network device and the terminal equipment, offsets of actually transmitted reference signals and/or synchronization signal blocks (SSBs), the number of pieces or the number of times of being unable to transmit due to LBT within a fourth predetermined period of time, and a parameter of a channel payload transmitted by the network device.

25. The apparatus according to any one of supplements 18-24, wherein the apparatus further includes:

a second receiving unit configured to receive the parameter of a channel payload transmitted by the terminal equipment, the parameter of a channel payload including at least one of a channel busy ratio, a channel occupancy, and an LBT success rate.

26. The apparatus according to supplement 25, wherein the parameter of a channel payload is transmitted via at least one of the following:

a radio resource control (RRC) connection reconfiguration complete message, a radio resource control (RRC) connection reestablishment complete message, a radio resource control (RRC) connection response complete message, a radio resource control (RRC) connection setup complete message, a measurement report message, a terminal equipment information response message, and a secondary cell group (SCG) information report message.

27. The apparatus according to any one of supplements 18-26, wherein the apparatus further includes:

a second configuring unit configured to configure the terminal equipment with one of the following parameters:

in a criterion for cell selection, a first threshold used for an unlicensed frequency band, the first threshold being different from or identical to a second threshold used for a licensed frequency band; or

an offset related to a channel payload and used for the criterion for cell selection determined by the network device; or

a measurement quantity related to the channel payload and used for the criterion for cell selection determined by the network device; or

a threshold and/or an offset of the measurement quantity related to the channel payload in the criterion for cell selection determined by the network device.

28. The apparatus according to any one of supplements 18-26, wherein the apparatus further includes:

a third configuring unit configured to configure following parameter(s) in performing cell reselection used by the terminal equipment:

a priority of a licensed frequency band being lower than a priority of an unlicensed frequency band; or

an offset related to a channel payload used for the cell reselection criterion determined by the network device; or

a measurement quantity related to the channel payload used for cell reselection criterion and determined by the network device; or

a threshold and/or an offset of the measurement quantity related to the channel payload in the cell reselection criterion determined by the network device.

29. A communication system, including a network device and a terminal equipment;

wherein the network device includes the radio link detection apparatus as described in any one of supplements 18-28, and the terminal equipment includes the radio link detection apparatus as described in any one of supplements 1-17.

What is claimed is:

1. A radio link detection apparatus, provided in a terminal equipment and comprising a detecting unit,
when a first timer related to radio link monitoring expires, the detecting unit determining that a radio link using an unlicensed frequency band fails,
or, when a higher layer of the terminal equipment receives a random access problem indication and a second timer related to reestablishment is not running, the detecting unit determining that a radio link using an unlicensed frequency band fails.

2. The apparatus according to claim 1, wherein the apparatus further comprises:
a first adjusting unit configured to adjust a parameter used for radio link failure detection and/or to adjust a radio link failure detection process according to a parameter of a channel payload obtained by the terminal equipment through measurement or according to parameters provided by a network device and used for transmission status of synchronization signal blocks and/or reference signals;
wherein the detecting unit determines according to the adjusted parameter and/or the adjusted process that a radio link using the unlicensed frequency band fails.

3. The apparatus according to claim 2, wherein,
the parameter used for radio link failure detection comprises at least one of the following:
a duration of a first timer (T310), the number (N310) of out-of-synchronization indication(s) starting the first timer (T310), the number (N311) of in-synchronization indications stopping the first timer (T310), and a duration of a fourth timer (T312) used for a fast radio link failure (fast RLF) detection;
or, the parameter used for radio link failure detection comprises at least one of the following:
a threshold of the number of times of random access preamble transmission used for controlling delivery of the random access problem indication to the higher layer of the terminal equipment, a length of a window related to a random access response, and a duration of a third timer related to random access contention resolution.

4. The apparatus according to claim 2, wherein the adjusted radio link failure detection process comprises at least one of the following steps:
when the number of out-of-synchronization indications reaches the number (N310) of out-of-synchronization indication(s) starting the first timer (T310), not starting the first timer (T310), but continuing to count, and starting the first timer (T310) until a first indication number (N313) is reached; wherein a value of the first indication number (N313) is determined according to the parameters provided by the network device and used for transmission status of synchronization signal blocks and/or reference signals;
when the first timer (T310) is not running, suspending an out-of-synchronization indication counter, using a first counter different from the out-of-synchronization indication counter, and recovering to count by the out-of-synchronization indication counter when a counting value of the first counter reaches the first indication number (N313); wherein a value of the first indication number (N313) is determined according to the parameters provided by the network device and used for transmission status of synchronization signal blocks and/or reference signals;
when the number of times of transmission of random access preambles reaches 1 more than the threshold, not indicating the random access problem by a media access control (MAC) sub-layer of the terminal equipment to the higher layer, but continuing to count the number of times of transmission of random access preambles, and reporting the random access problem to the higher layer until the counting reaches a first number (N1), a value of the first number being determined according to the parameters provided by the network device and used for transmission status of synchronization signal blocks and/or reference signals; and
suspending a counter of the number of times of transmission of random access preambles, using a second counter different from the counter of the number of times of transmission of random access preambles, and recovering to count by the counter of the number of times of transmission of random access preambles until the second counter reaches a second number (N2), a value of the second number being determined according to the parameters provided by the network device and used for transmission status of synchronization signal blocks and/or reference signals.

5. The apparatus according to claim 2, wherein,
the parameter of a channel payload is a parameter representing a channel usage status.

6. The apparatus according to claim 5, wherein,
the parameter of a channel payload comprises at least one of the following:
a channel busy ratio, a channel occupancy, and a listen-before-talk (LBT) success rate.

7. The apparatus according to claim 6, wherein,
the listen-before-talk (LBT) success rate is a ratio of the number of times of success of listen-before-talk within a third predetermined period of time to the number of times of all listen-before-talk within the third predetermined period of time.

8. The apparatus according to claims 2, wherein the apparatus further comprises:
a first receiving unit configured to receive a configuration of the network device;
wherein the first adjusting unit adjusts the parameter used for radio link failure detection based on the configuration of the network device.

9. The apparatus according to claim 1, wherein the apparatus further comprises:
a selecting unit configured to perform cell selection or cell reselection when the radio link in a primary cell group fails.

10. The apparatus according to claim 9, wherein,
when the selecting unit performs cell selection,
in a criterion for cell selection, a first threshold is used for the unlicensed frequency band, the first threshold being different from or identical to a second threshold used for a licensed frequency band; or
the criterion for cell selection is adjusted by an offset related to a channel payload determined by the network device; or
in the criterion for cell selection, a measurement quantity related to the channel payload determined by the network device is used; or
in the criterion for cell selection, a threshold and/or an offset of the measurement quantity related to the channel payload determined by the network device is/are used.

11. The apparatus according to claim 9, wherein,
when the selecting unit performs cell reselection,
the terminal equipment sets a priority of the unlicensed frequency band to be lower than a priority of the licensed frequency band; or
a criterion for cell reselection is adjusted by an offset related to a channel payload determined by the network device; or
in the criterion for cell reselection, a measurement quantity related to the channel payload determined by the network device is used; or
in the criterion for cell reselection, a threshold and/or an offset of the measurement quantity related to the channel payload determined by the network device is/are used.

12. The apparatus according to claim 1, wherein the apparatus further comprises:
a first transmitting unit configured to transmit a parameter of a channel payload to a network device when the radio link fails, the parameter of a channel payload comprising at least one of a channel busy ratio, a channel occupancy, and an LBT success rate.

13. The apparatus according to claim 12, wherein the parameter of a channel payload is transmitted via at least one of the following:
a radio resource control (RRC) connection reconfiguration complete message, a radio resource control (RRC) connection reestablishment complete message, a radio resource control (RRC) connection response complete message, a radio resource control (RRC) connection setup complete message, a measurement report message, a terminal equipment information response message, and a secondary cell group (SCG) information report message.

14. The apparatus according to claim 1, wherein the apparatus further comprises:
a second adjusting configured to control a physical layer of the terminal equipment to determine whether to report an out-of-synchronization indications to the higher layer of the terminal equipment according to a relationship between a measurement quantity and a threshold in a combination of thresholds, or according to a relationship between a parameter of a channel payload and a threshold;
wherein the combination of thresholds comprises at least two thresholds,
and the detecting unit determines that the radio link using the unlicensed frequency band fails based on the received out-of-synchronization indication and according to a parameter used for radio link failure detection.

15. A radio link detection apparatus, provided in a network device and comprising a configuring and transmitting unit, the configuring and transmitting unit,
configuring a terminal equipment to adjust a parameter used for radio link failure detection and/or to adjust a radio link failure detection process according to a parameter of a channel payload, or
transmitting parameters used for representing a transmission status of synchronization signal blocks and/or reference signals to the terminal equipment, such that the terminal equipment adjusts the parameter used for radio link failure detection and/or adjusts the radio link failure detection process.

16. The apparatus according to claim 15, wherein,
the parameter of a channel payload is a parameter representing a channel usage status.

17. The apparatus according to claim 15, wherein,
the parameters used for representing transmission status of synchronization signal blocks and/or reference signals and provided by the network device comprise at least one of the following:
information on actually transmitted synchronization signal blocks between the network device and the terminal equipment, offsets of actually transmitted reference signals and/or synchronization signal blocks (SSBs), the number of pieces or the number of times of being unable to transmit due to LBT within a fourth predetermined period of time, and the parameter of a channel payload transmitted by the network device.

18. The apparatus according to claim 15, wherein the apparatus further comprises:
a second configuring unit configured to configure the terminal equipment with at least one of the following parameters:
in a criterion for cell selection, a first threshold used for an unlicensed frequency band, the first threshold being different from or identical to a second threshold used for a licensed frequency band; or
an offset related to a channel payload and used for cell selection determined by the network device; or
a measurement quantity related to the channel payload and used for cell selection determined by the network device; or
a threshold and/or an offset of the measurement quantity related to the channel payload and used for cell selection determined by the network device.

19. The apparatus according to claim 15, wherein the apparatus further comprises:
a third configuring unit configured to configure following parameter(s) in performing cell reselection used by the terminal equipment:
a priority of a licensed frequency band being higher than a priority of an unlicensed frequency band; or
an offset related to a channel payload and used for the cell reselection criterion determined by the network device; or
a measurement quantity related to the channel payload and used for cell reselection criterion determined by the network device; or
a threshold and/or an offset of the measurement quantity related to the channel payload in the cell reselection criterion determined by the network device.

20. A communication system, comprising a network device and a terminal equipment;
wherein the network device comprises a radio link detection apparatus including a configuring and transmitting unit, the configuring and transmitting unit,
configuring a terminal equipment to adjust a parameter used for radio link failure detection and/or to adjust a radio link failure detection process according to a parameter of a channel payload, or
transmitting parameters used for representing a transmission status of synchronization signal blocks and/or reference signals to the terminal equipment, such that the terminal equipment adjusts the parameter used for radio link failure detection and/or adjusts the radio link failure detection process, and the terminal equipment comprises the radio link detection apparatus as claimed in claim 1.
